(19) United States
(12) Patent Application Publication
(10) Pub. No.: US 2003/0231326 A1
(43) Pub. Date: Dec. 18, 2003

(54) Method and apparatus for improving information storage using compressed and non-compressed data

(76) Inventors: Robert M. Jackson, Eagle, ID (US); Marvin D. Nelson, Meridian, ID (US); Chris Brooks, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/175,481

(22) Filed: Jun. 18, 2002

(51) Int. Cl. G06F 3/12; G06F 15/00; G06F 13/00

(52) U.S. Cl. 358/1.11; 358/1.15; 358/1.16

(57) ABSTRACT

Information storage associated within a memory device is improved using a combination of compressed and non-compressed data storage formats. Font data may be stored without compression, thereby reducing the overhead associated with decompression and the need to supply sufficient memory to accommodate the font after decompression. Executable code is compressed for storage.

### TECHNICAL FIELD

This disclosure relates to segregating compressed and non-compressed data within memory.

### BACKGROUND

The firmware contained within many printers contains executable software code and font data that is stored within read only memory (ROM). Both the software and the font data are compressed to minimize the size of the ROM required. Upon initiating a power-up sequence, the executable software is extracted from the ROM, decompressed, and transferred to read only memory (RAM) for operation. Similarly, the font data is also extracted, decompressed and transferred to RAM, as needed.

Due to differences in the nature of the executable software and the font data, the compression of the executable software is more effective than is the compression of the font data. As a result, the compression process fails to significantly reduce the ROM space required for storage of font data. Moreover, the decompression process requires time and RAM space to complete, as well as additional RAM space to store the decompressed font data.

In the context of low-cost printers, the failure of compression algorithms to significantly reduce the size of font data, combined with the overhead involved in the decompression process, is a significant cost burden. Accordingly, the cost of manufacturing low-end printers has been difficult to reduce.

### SUMMARY

Information storage associated within a memory device is improved using a combination of compressed and non-compressed data storage formats. Font data may be stored without compression, thereby reducing the overhead associated with decompression and the need to supply sufficient memory to accommodate the font after decompression. Executable code is compressed for storage.

### BRIEF DESCRIPTION OF THE DRAWINGS

The same reference numbers are used throughout the drawings to reference like features and components.

FIG. 1 illustrates an environment within which information storage is improved by using an embodiment of memory having compressed and non-compressed data.

FIG. 2 is a block diagram that illustrates detail of the components contained within the printer embodiment of FIG. 1.

FIG. 3 is a flow chart that describes an embodiment for configuring firmware by which some information is stored in a compressed format, while other information is stored in a non-compressed format.

FIG. 4 is a flow chart that illustrates an embodiment by which both non-compressed and compressed font libraries may be built and located on the ROM.

FIG. 5 is a flow chart that illustrates an embodiment for determining which fonts should be considered frequently or infrequently used, and thereby offers greater insight into the operation of block 402 of FIG. 4.

### DETAILED DESCRIPTION

Information storage associated within a ROM, non-volatile RAM (NVRAM) or other non-volatile memory device is improved using a combination of compressed and non-compressed data storage formats. Font data may be stored within the non-volatile memory device, herein after referred to as ROM, without compression, thereby reducing the overhead associated with decompression and the need to supply sufficient RAM to accommodate the font after decompression. Executable code is compressed and moved to the ROM for storage.

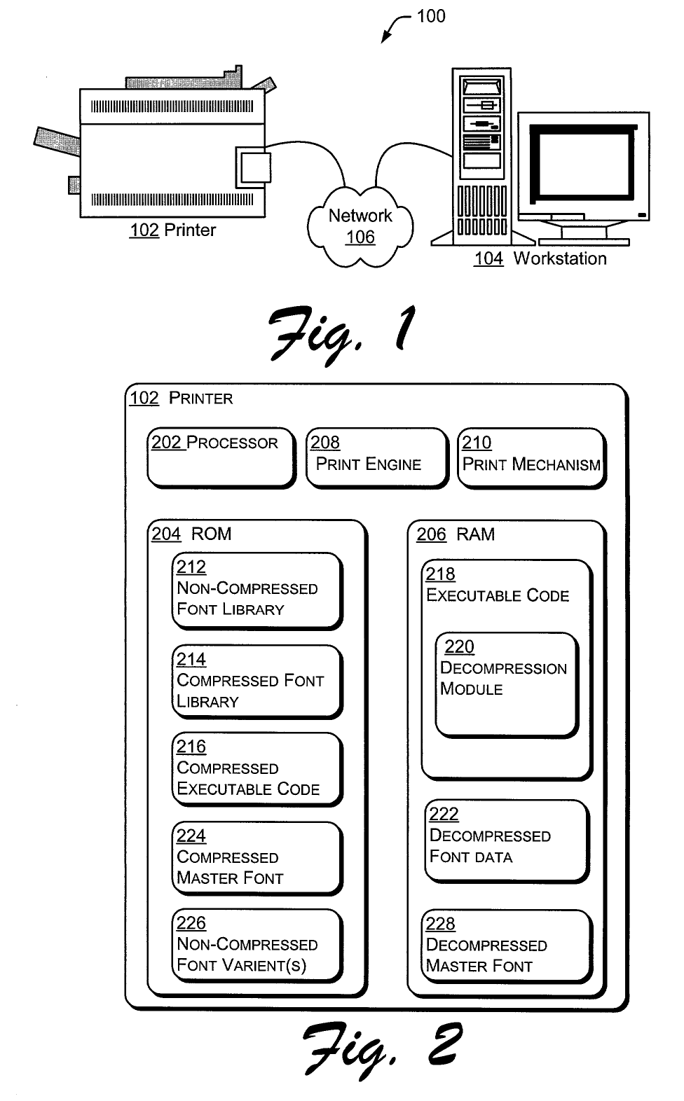

FIG. 1 shows a system 100 wherein a printer 102 illustrates an example of improved information storage using compressed and non-compressed formats. The printer communicates with a workstation 104 or other client computer over a network 106. The printer 102 may be any device containing firmware, such as the exemplary printer shown, a digital copier, a multifunction peripheral or other output device. The network may be a cable, a LAN (local area network), a WAN (wide area network), the Internet or other network topology or technology.

FIG. 2 is a block diagram that illustrates the components contained within an embodiment exemplified by printer 102 of FIG. 1. A processor 202 reads and/or writes to memory, including a ROM 204 and RAM 206. The processor is in communication with a print engine 208, which in turn configures data, such as raster, used to drive a print mechanism 210. The print mechanism may be based on a laser engine or other print technology.

The ROM 204 contains a non-compressed font library 212, which contains font data and information associated with at least one font in a non-compressed data storage format. For example, Times New Roman font may be stored in a non-compressed data format within the non-compressed font library.

A compressed font library 214 may optionally be included. The compressed font library contains font data and information associated with at least one font in a compressed data storage format. For example, Arial font may be stored in a compressed data format within the compressed font library. Generally, fonts are stored within the compressed font library only where the font is consistently or heavily used, and where resources, including available RAM space, are available for decompression and use of the font.

At least one compressed executable code file 216 is contained in ROM. The executable code file is decompressed upon a printer start-up or power-on sequence, resulting in the executable code file 218, seen in the RAM device 206. Execution of the executable code by the processor 202 supports the printer functionality; for example, instructions included within the executable code enable the processor to control operation of the print engine 208 and print mechanism 210. Additionally, a decompression module 220, which may be located within the executable code or other location, is configured to decompress the compressed font data 214, resulting in decompressed font data 222, which is located in RAM.

A master font 224 is a font that may be varied, by the addition of a font variant, to become a unique font. Thus, one master font and a plurality of font variants can provide the functionality of a plurality of conventional fonts. The master font typically contains some information that is common to all fonts. The font variants include information, such as serifs, that vary among different fonts.

Where the master font is heavily used, it may be contained in a file having a compressed format 224. Where it is not heavily used, it may be contained within the non-compressed font library 212. Similarly, heavily used font variants may be stored in the compressed font library 214; lesser used font variants may be stored in the non-compressed font library 212.

Where the master font was stored in a compressed format, it may be decompressed and relocated to a file 228 located in RAM. Similarly, any compressed font variants may be decompressed and located with other decompressed font data 222. Where the master font, or any font variants, was not compressed, it can be accessed, as needed, from ROM.

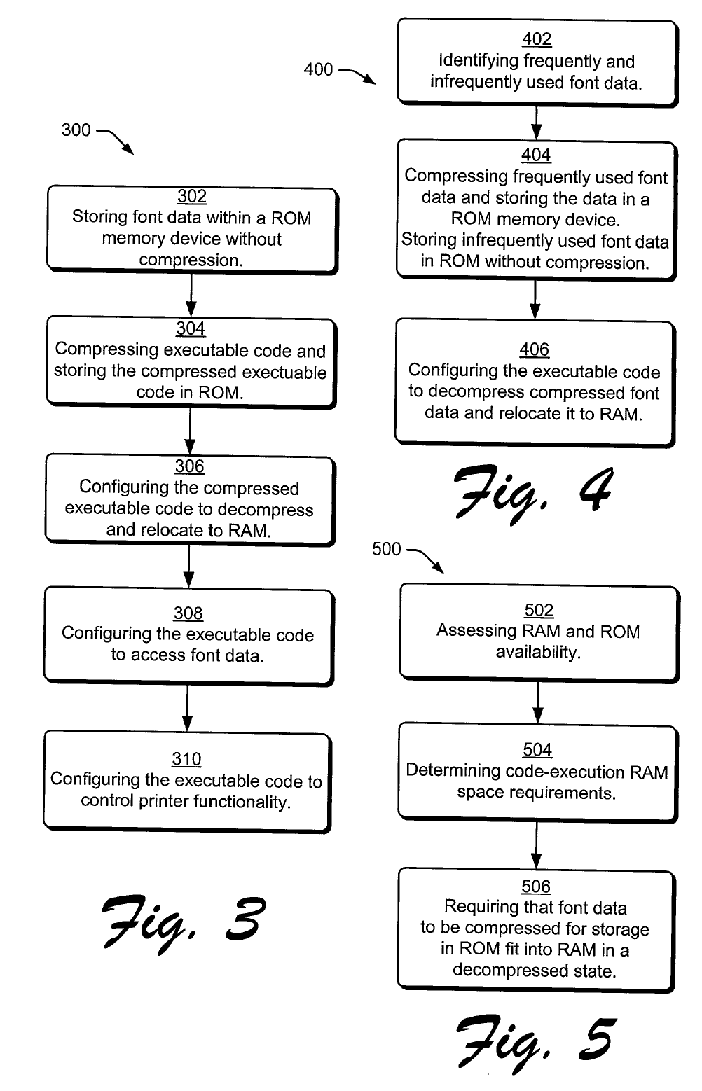

The flow chart of FIG. 3 illustrates an embodiment 300 for configuring firmware by which some information is stored in a compressed format, while other information is stored in a non-compressed format. The elements of the embodiment may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed in a manner which associates actions with more than one other block.

At block 302, font data is stored in a ROM memory device without compression. This may include all or part of the available font data, and specifically may include data and information associated with: all fonts, lesser used fonts, and font variants.

At block 304, executable code is compressed and stored in the ROM memory device. The executable code may be configured for any purpose, such as printer operation, including direction of the print engine and print mechanism.

At block 306, the compressed executable code, which has been appropriately configured to do so, decompresses and relocates to RAM.

At block 308, the executable code, which has been appropriately configured to do so, accesses the uncompressed font data in ROM. Alternatively, previously compressed font data (such as from library 214 in FIG. 2) may be accessed from RAM. The font data is thereby available for any need, such as to configure information for transmission to the print engine and print mechanism.

At block 310, the executable code, which has been appropriately configured to do so, controls printer functionality. This includes such operations as control of the processor, print engine.

The flow chart of FIG. 4 illustrates an embodiment 400 by which both non-compressed and compressed font libraries may be built and located on the ROM. In particular, the embodiment determines which specific fonts should be located within each library. The elements of the embodiment may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed in a manner which associates actions with more than one other block.

At block 402, frequently and infrequently used font data are identified. The size, composition and exact membership of each group is determined somewhat by the size of ROM and RAM available, as well as the size of individual fonts and groups of fonts and the predicted preferences of the user for whom the fonts are being selected. Accordingly, selection of any individual font, and the group within which it is located, may depend on the specific application.

At block 404, frequently used font data is compressed and stored in ROM, while infrequently used font data is stored in ROM without compression. In particular, the non-compressed and compressed font data may be stored within the non-compressed and compressed font libraries 212, 214 of FIG. 2.

At block 406, the executable code, which has been appropriately configured to do so, decompresses any needed compressed font data and relocates it to RAM.

The flow chart of FIG. 5 illustrates an embodiment 500 for determining which fonts should be considered frequently or infrequently used, and thereby offers greater insight to the operation of block 402 of FIG. 4. The elements of the embodiment may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed in a manner which associates actions with more than one other block.

At block 502, the quantities of RAM and ROM memory available are assessed. The greater the amount of RAM available, the greater the number of fonts which may be considered to be frequently used. Such frequently used fonts may therefore be compressed for storage in ROM and decompressed for operation in RAM without causing a shortage of RAM which would slow printer operation. Alternatively, the sizes of ROM and RAM may be selected based on the expected needs of the fonts required. In a still further alternative, the sizes of ROM and RAM and the number of fonts available may be determined by the overall target cost of the printer or other device.

At block 504, the code-execution RAM space requirements are determined. The size of the executable code, as well as the size of the space required for data, is considered in the determination. The RAM left over after deduction for space required to perform the code-execution is therefore the most that can be considered to be available for use in the storage of decompressed fonts.

At block 506, an additional constraint requires that the font data which is compressed for storage in ROM must fit into RAM in a decompressed state without negative impact on the operation of the executable code. This requirement must be made in view of the RAM needed for storage of the executable code and other required data.

In conclusion, information storage associated with low-cost printers is improved using a combination of compressed and non-compressed data storage formats. Font data is stored within a ROM without compression, thereby reducing the overhead associated with decompression and the need to supply sufficient RAM to accommodate the font after decompression. Executable code is compressed, and is stored to the ROM in the compressed format.

Although the disclosure has been described in language specific to structural features and/or methodological steps, it is to be understood that the appended claims are not limited to the specific features or steps described. Rather, the specific features and steps are exemplary forms of implementing this disclosure. For example, while some effort has been made to describe embodiments by which decisions can be made as to which fonts should be compressed and which fonts should not be compressed, some benefit may be derived simply by not compressing one or more fonts, when storing the one or more fonts in ROM. This will result in increased RAM availability, since the decompressed font may be accessed out of ROM. Some gain in RAM is also obtained because decompression is not involved, thereby lessening the RAM requirements of the executable code. Additionally, while one or more embodiments have been disclosed by means of flow charts and text associated with the blocks, it is to be understood that the blocks do not necessarily have to be performed in the order in which they were presented, and that an alternative order may result in similar advantages.

1. A processor-readable medium comprising processor-executable instructions for:
storing font data within a first type of memory without compression;
compressing executable code, thereby forming compressed executable code; and
storing the compressed executable code in the first type of memory.

2. A processor-readable medium as recited in claim 1, comprising further instructions for:
configuring the compressed executable code to decompress, thereby reforming the executable code; and
configuring the executable code to move to a second type of memory.

3. A processor-readable medium as recited in claim 1, comprising further instructions for:
configuring the executable code to access the font data contained within the first type of memory.

4. A processor-readable medium as recited in claim 1, comprising further instructions for:
configuring the executable code to control printer functionality.

5. A processor-readable medium as recited in claim 1, comprising further instructions for:
compressing additional font data, thereby forming compressed font data; and
storing the compressed font data in the first type of memory.

6. A processor-readable medium as recited in claim 5, comprising further instructions for:
configuring the executable code to decompress the compressed font data, thereby forming decompressed font data; and
configuring the executable code to store the decompressed font data in a second type of memory.

7. A processor-readable medium as recited in claim 1, comprising further instructions for:
identifying infrequently used font data and frequently used font data; and
storing the frequently used font data in the first type of memory with compression.

8. A processor-readable medium as recited in claim 7, wherein identifying infrequently used font data comprises further instructions for:
assessing availability of a second type of memory;
determining code-execution memory space requirements within the second type of memory; and
requiring that the infrequently used font data fit within the second type of memory in a decompressed state, in view of the code-execution memory space requirements of the second type of memory and availability of the second type of memory.

9. A processor-readable medium as recited in claim 1, comprising further instructions for:
storing master font data in the first type of memory with compression; and
storing font variant data in the first type of memory without compression.

10. A method for configuring firmware, comprising:
storing font data within a ROM memory device without compression;
compressing executable code, thereby forming compressed executable code; and
storing the compressed executable code in the ROM memory device.

11. The method of claim 10, additionally comprising:
configuring the compressed executable code to decompress, thereby reforming the executable code; and
configuring the executable code to move to a RAM memory device.

12. The method of claim 11, additionally comprising:
configuring the executable code to access the font data contained within the ROM.

13. The method of claim 12, additionally comprising:
configuring the executable code to control printer functionality.

14. The method of claim 13, additionally comprising:
identifying infrequently used font data and frequently used font data;
assessing RAM memory availability;
determining code-execution RAM space requirements;
requiring that frequently used font data fit within RAM in a decompressed state, in view of the code-execution RAM space requirements and the RAM memory availability; and
storing the frequently used font data in the ROM memory device with compression.

15. The method of claim 14, additionally comprising:
configuring the executable code to decompress the frequently used font data, thereby forming decompressed font data; and
configuring the executable code to store the decompressed font data within RAM.

16. The method of claim 15, additionally comprising:
storing master font data in the ROM memory device with compression; and
storing font variant data in the ROM memory device without compression.

17. A printer, comprising:
a RAM memory device;
a ROM memory device;
a non-compressed font data library, defined on the ROM memory device, comprising data associated with at least one non-compressed font; and
a compressed executable code file configured, upon conversion by decompression into an executable code file, and upon and relocation into the RAM memory device, to support printer functionality.

18. The printer of claim 17, additionally comprising:
a compressed font data library, defined on the ROM memory device, comprising font data associated with at least one compressed font.

19. The printer of claim 18, additionally comprising:
a compression module, located within the executable code file, configured to decompress font data found within the compressed font data library, thereby creating decompressed font data, and configured to store the decompressed font data on the RAM memory device.

20. The printer of claim 18, additionally comprising:
a master font, stored in the compressed font data library; and
at least one font style variant, stored in the non-compressed font data library.

21. A processor-readable medium comprising processor-executable instructions for configuring firmware, the processor-executable instructions comprising instructions for:
storing non-compressed font information in a ROM memory device; and
storing compressed executable code on the ROM memory device, wherein the compressed executable code is configured to decompress and thereby form executable code, and is configured to relocate to a RAM memory device, and to access the non-compressed font information.

22. A processor-readable medium as recited in claim 21, comprising further instructions for:
storing compressed font information in the ROM memory device; and
configuring the executable code to decompress the compressed font information in the ROM memory device.

23. A processor-readable medium as recited in claim 22, wherein storing the compressed font information comprises storing frequently used font information.

24. A processor-readable medium as recited in claim 21, comprising further instructions for:
identifying frequently used font data; and
storing the frequently used font data in the ROM device in a compressed format.

25. A processor-readable medium as recited in claim 21, wherein storing non-compressed font information comprises storing infrequently used font information.

26. A method of configuring firmware using compressed and non-compressed formats information, comprising:
storing non-compressed font information in a ROM memory device; and
storing compressed executable code on the ROM memory device, wherein the compressed executable code is configured to decompress and thereby form executable code, and is configured to relocate to a RAM memory device, and to access the non-compressed font information.

27. The method of claim 26, additionally comprising:
storing compressed font information in the ROM memory device; and
configuring the executable code to decompress the compressed font information in the ROM memory device.

28. The method of claim 27, wherein storing compressed font information comprises storing frequently used font information.

29. The method of claim 28, additionally comprising:
identifying frequently used font data; and
storing the frequently used font data in the ROM device in a compressed format.

30. The method of claim 29, wherein storing non-compressed font information comprises storing infrequently used font information.

31. A printer, comprising:
means for storing infrequently used font data within a ROM memory device without compression;
means for compressing frequently used font data, thereby forming compressed font data and storing the compressed font data in the ROM memory device;
means for compressing executable code, thereby forming compressed executable code and storing the compressed executable code in the ROM memory device;
means for configuring the compressed executable code to decompress, thereby reforming the executable code, and to move to a RAM memory device for execution;
means for configuring the executable code to access infrequently used font data contained within the ROM; and
means for configuring the executable code to decompress the frequently used font data to store the frequently used font data, after decompression, in the RAM device.

32. The printer of claim 31, additionally comprising:
means for assessing RAM memory availability;
means for determining code-execution RAM space requirements; and
means for designating font data as frequently used font data only where sufficient space within RAM memory is available for storage of the font data.

33. The printer of claim 31, additionally comprising:
means for storing master font data in the ROM memory device with compression; and
means for storing font variant data in the ROM memory device without compression.
